(19) United States
(12) Patent Application Publication
(10) Pub. No.: US 2002/0031208 A1
(43) Pub. Date: Mar. 14, 2002

(54) Apparatus and method for processing voice messages

(76) Inventors: Hans-Juergen Hauschild, Paderborn (DE); Bernd Hinz, Rheda-Wiedenbrueck (DE)

Correspondence Address: William E. Vaughan, Bell, Boyd & Lloyd LLC, P.O. Box 1135, Chicago, IL, 60690, US

(21) Appl. No.: 09/900,691

(22) Filed: Jul. 6, 2001

(30) Foreign Application Priority Data
Jul. 6, 2000 (DE) 100 32 828.8

(51) Int. Cl. H04M 1/64

(52) U.S. Cl. 379/88.22

(57) ABSTRACT

A voice processing apparatus and method for processing voice messages from a voice message system, having a reception apparatus for sequentially receiving voice messages, a memory apparatus for separately storing individual voice messages, and a playback apparatus for randomly playing back the stored voice messages.

### BACKGROUND OF THE INVENTION

1. Field of the Invention

The present invention relates to a voice processing apparatus for processing voice messages from a voice memory system and to a method for processing voice messages from such a voice memory system.

2. Description of the Prior Art

Voice memory systems, frequently referred to as voice mail systems in the literature, are systems which essentially provide the functions of an answering machine for recording voice messages. Unlike conventional answering machines, such voice mail systems are not situated locally, or connected directly to a terminal, but rather are located centrally in a telecommunication system; e.g., in a telecommunication installation in a private telecommunication network or in an exchange in a public telecommunication network.

“Product specification “HICOM 300 ‘Voice Mail Service VMS’”: Siemens AG, 1995, Order No.: A31002-S10-A1-7-5” discloses, by way of example, such a voice memory system “Voice Mail Service VMS” integrated in a private ISDN exchange. This voice memory system is used for storing, retrieving and distributing messages in natural language. The users registered in the voice memory system have a personal mailbox (“voice mailbox”) allocated to them for this purpose. In their absence, mailbox owners can divert the calls intended for them to their mailbox, which then stores the messages transmitted with the calls.

By dialing up his/her mailbox, the registered user can use a telephone, for example, to listen to the stored messages at any time and irrespective of location. An audible user guide simplifies use of the voice memory system. The use of such a voice memory system is generally based on the following steps:

the voice memory system is dialed up, e.g. using a telephone;

a spoken menu is heard, e.g. “Please press the number 3 to listen to a voice mail”, or “Please press the number 6 to erase the voice mail”;

the desired function is performed by pressing a button; and

the voice memory system is exited by putting down the telephone receiver.

In this context, the voice memory system is generally controlled using the keypad on the telephone; e.g., using frequency tones which can be activated using the pushbutton dialing block on a terminal on the basis of the dual tone multifrequency (DTMF) dialing method.

The drawback of this solution is that a subscriber initially receives no overview of all his received voice messages (voice mails). In addition, it is only possible to listen to the voice messages sequentially. Random access to the voice messages is not possible.

Furthermore, use is very complex and laborious, since it is first necessary to listen to a spoken menu, and only then is it possible to perform a desired function by pressing a button. It also is not possible to process the voice messages further (the voice messages can merely be listened to, stored or erased).

The present invention is, therefore, focused on providing a voice processing apparatus for processing voice messages from a voice memory system and a method for processing voice messages from a voice memory system which permit random access to received voice messages.

### SUMMARY OF THE INVENTION

As such, in accordance with the present invention, voice messages stored in the voice memory system are requested and received sequentially by the voice processing apparatus, and each individual voice message is stored separately. The voice messages stored in the voice processing apparatus then can be accessed randomly by a user.

The signals required for controlling the voice memory system, for example for signaling on the basis of the DTMF method, are automatically generated and sent to the voice memory system by a transmission apparatus associated with the voice processing apparatus. This allows the user of the inventive voice processing apparatus to retrieve his/her voice messages from the voice memory system via a simple input; e.g., the touch of a button or a mouse click.

The voice processing apparatus according to the present invention is advantageously provided in a personal computer (PC) equipped with appropriate hardware and software. In this context, simple control of the inventive voice processing apparatus by a user is suitably provided for by a graphical user interface which can be used to perform the individual actions, such as picking up all voice messages from the voice memory system, via an input using an input apparatus; e.g., a mouse or a keyboard.

In one embodiment of the present invention, each voice message picked up is recorded in a respective file, e.g. in wave format, and is sent as an attachment to an electronic mail message (referred to as e-mail in the literature) to the user's e-mail program. The user thus obtains an overview of all the received voice messages in the inbox of his/her e-mail program and is then able to open an e-mail randomly and play back the voice message in the form of the file.

By storing the voice messages in a respective file in a particular file format, the voice messages also can be processed further; e.g., by converting the voice into text using a voice recognition system. In addition, the individual voice messages or files can be conveniently be forwarded to other subscribers.

Once the voice messages held in the voice memory system have been received, the voice messages in the voice memory system are automatically erased by an erasing apparatus associated with the voice processing apparatus. In this context, the erasing apparatus sends appropriate signals to the voice memory system.

Additional features and advantages of the present invention are described in, and will be apparent from, the Detailed Description of the Preferred Embodiments and the Drawings.

### DESCRIPTION OF THE DRAWINGS

FIG. 1 shows a schematic illustration of the voice processing apparatus according to the teachings of the present invention.

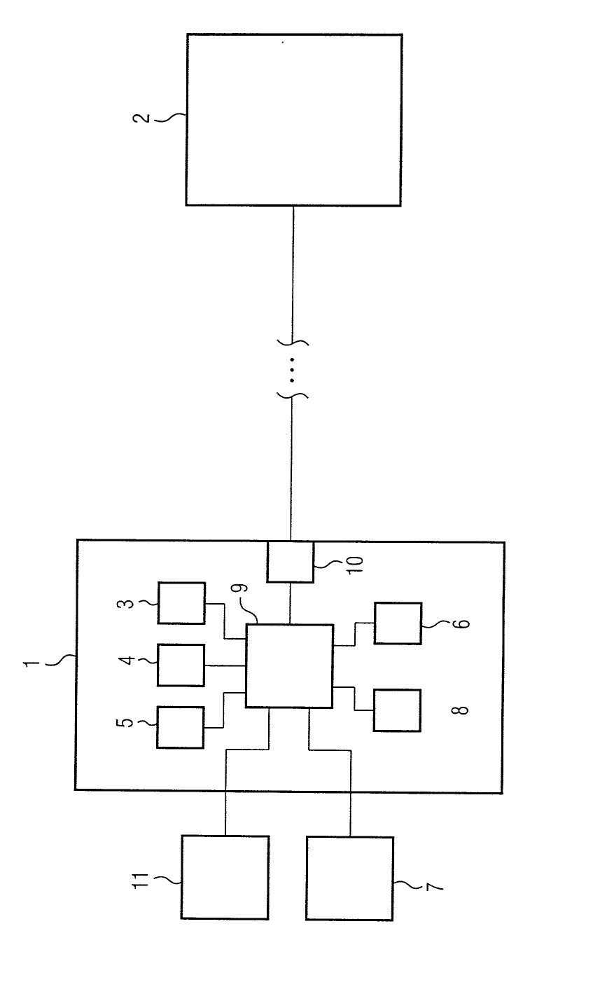

### DETAILED DESCRIPTION OF THE PREFERRED EMBODIMENTS

The inventive voice processing apparatus 1 is advantageously integrated in a conventional personal computer having an interface 10 to a telecommunication network. The voice processing apparatus 1 includes a reception apparatus 3 for receiving the voice messages from the voice memory system 2, a memory apparatus 4 (e.g., a hard disk) for separately storing the individual voice messages received from the voice memory system 2, and a playback apparatus 5 for randomly playing back the individual voice messages stored in the memory apparatus 4.

In addition, a transmission apparatus 6 for automatically generating and transmitting signals required for controlling the voice memory system 2 and an erasing apparatus 8 for generating signals for automatically erasing the received voice messages in the voice memory system 2 are integrated in the inventive voice processing apparatus 1. In this context, the signals are generated on the basis of the dual tone multifrequency (DTMF) dialing method, for example.

The user inputs are made using an input apparatus 7, for example a keyboard or a mouse, connected to the voice processing apparatus 1, employing a graphical user interface (GUI) which is shown on a screen 11 connected to the voice processing apparatus 1.

In this context, the input and output operations, the interfaces within the apparatus and the individual apparatuses or functional units of the voice processing apparatus 1 are controlled by a central processing unit 9 (CPU).

The way in which the inventive voice processing apparatus 1 works is explained below using an example where a number of voice messages are stored in the voice memory system 2 for a user or subscriber.

Using the input apparatus 7, the user can have a control element on the graphical user interface prompt all the voice messages to be automatically retrieved from the voice memory system 2 and transmitted to the voice processing apparatus 1.

In this case, a connection to the voice memory system 2 is set up via the interface 10. In this context, the connection can be set up over a telecommunication network (public or private) or else over a computer network, for example an LAN (Local Area Network) or the Internet.

The transmission apparatus 6 generates and then sends the signals required for retrieving the voice messages held in the voice memory system 2, such as the signals for the menu functions and any signals required for inputting a PIN number. In this context, by way of example, these signals correspond to the keypad input using the telephone on the basis of the dual tone multifrequency (DTMF) dialing method.

In accordance with the present invention, a user action which has been prompted using a control element on the graphical user interface is, thus, automatically converted into signals which are required for setting up the connection, for picking up the voice messages and for clearing down the connection between the voice processing apparatus 1 and the voice memory system 2.

Once the voice messages have been requested and received from the voice memory system 2 by the reception apparatus 3 and the individual voice messages have been separately stored in the memory apparatus 4, the erasing apparatus 8 generates the signals required for erasing the voice messages in the voice memory system 2 and sends them to the voice memory system 2.

In one embodiment of the present invention, the individual voice messages are sent as a respective e-mail with the voice message as attachment, e.g. a file in “wave format”, to an e-mail program associated with the user in the inventive voice processing apparatus 1. The individual voice messages are then available to the user as respective e-mail attachments in the inbox of his/her e-mail program. The user is then able to open an e-mail randomly, e.g. with a mouse click, and have the attachment or the voice message played back by a playback apparatus, e.g. the e-mail program.

In accordance with the present invention, a conventional voice mail system is thus controlled using a convenient graphical user interface.

Although the present invention has been described with reference to specific embodiments, those of skill in the art will recognize that changes may be made thereto without departing from the spirit and scope of the invention as set forth in the hereafter appended claims.

We claim as our invention:

1. A voice processing apparatus for processing individual voice messages stored in a voice memory system, wherein the voice memory system is controllable via the voice processing apparatus using particular signals, the voice processing apparatus comprising:
a reception apparatus for sequentially receiving the individual voice messages stored in the voice memory system;
a memory apparatus for separately storing the individual voice messages; and
a playback apparatus for randomly playing back the stored individual voice messages.

2. A voice processing apparatus for processing individual voice messages stored in a voice memory system as claimed in claim 1, further comprising:
a transmission apparatus for automatically generating and sending the particular signals required for controlling the voice memory system.

3. A voice processing apparatus for processing individual voice messages stored in a voice memory system as claimed in claim 1, wherein the particular signals are formed based on a dual tone multifrequency dialing method.

4. A voice processing apparatus for processing individual voice messages stored in a voice memory system as claimed in claim 1, further comprising:
a display apparatus, the display apparatus having a graphical user interface for controlling the voice processing apparatus.

5. A voice processing apparatus for processing individual voice messages stored in a voice memory system as claimed in claim 1, wherein the stored individual voice messages are made available to a user as a respective attachment to an e-mail.

6. A voice processing apparatus for processing individual voice messages stored in a voice memory system as claimed in claim 1, further comprising:
an erasing apparatus for automatically erasing the individual voice messages in the voice memory system which already have been received.

7. A method for processing individual voice messages from a voice memory system, wherein the voice memory system is controllable via particular signals, the method comprising the steps of
receiving, sequentially, the individual voice messages stored in the voice memory system;
storing, separately, the individual voice messages; and
playing back, randomly, the stored individual voice messages.

8. A method for processing individual voice messages from a voice memory system as claimed in claim 7, the method further comprising the step of:
generating and sending, automatically, the particular signals required for controlling the voice memory system.

9. A method for processing individual voice messages from a voice memory system as claimed in claim 7, the method further comprising the step of:
making available to a user stored individual voice messages as a respective attachment to an e-mail.

10. A method for processing individual voice messages from a voice memory system as claimed in claim 7, the method further comprising the step of:
erasing, automatically, the individual voice messages in the voice memory system which already have been received.
